(19) United States
(12) Patent Application Publication
(10) Pub. No.: US 2009/0307836 A1
(43) Pub. Date: Dec. 17, 2009

(54) SHOWER HEAD

(76) Inventors: Joachim Blattner, Haslach (DE); Ulrich Kinle, Schenkenzell (DE)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/477,441

(22) Filed: Jun. 3, 2009

(30) Foreign Application Priority Data
Jun. 6, 2008 (DE) 10 2008 028 215.4

(51) Int. Cl. B05B 1/14

(52) U.S. Cl. 4/615

(57) ABSTRACT

A showerhead contains a chamber in connection with a connecting nozzle, said chamber from which the water is discharged from plurality of nipples formed on a membrane formed out of elastomeric material. The nipples feature a duct for the shower water. The nipples penetrate through openings of a perforated disc through the openings slightly larger than the outside diameter of the nipple. By shifting the perforated disc in a plane parallel to the membrane featuring the nipples, the direction of the nipple and thus the direction of the water jets discharged from the nipples will be changed. This adjustment can occur in two directions that are perpendicular to one another. The membrane is preferably approximately plane in shape, so that a front surface of the showerhead is likewise plane in shape.

The invention relates to a showerhead for a sanitary fitting with several jet outlet elements that discharge the shower water as outlet jet in a defined direction.

A side shower is already known, in which perforations in a row are disposed on the front side of a pipe, through which the hose pieces project. On the external side of the pipe, a sleeve is attached, which features corresponding openings. By shifting this sleeve, the direction of the hose pieces can be changed together. Through the hose pieces water comes out through a direction determined by the arrangement of the hose pieces (DE 3044310).

The invention is based on the task of providing a showerhead that allows a variety of applications and easy handling.

To solve this task the invention proposes a showerhead for a sanitary fitting with the features cited in claim 1. Further developments of the invention are object of dependent claims.

Although in the state of the art the side shower only has one row of jet outlet elements, the showerhead according to the invention features jet outlet elements that are disposed in a surface. These jet outlet elements are adjustable in at least two directions at an angle to one another, for example an angle of 90°.

In a further development of the invention, it can be provided that the adjustment can be performed by the user holding the housing of the showerhead itself, so that an additional lever or actuation element that could disturb the appearance of the showerhead housing is dispensed with.

The direction, in which the jet outlet elements with their outlet jets can be adjusted, can be provided by a forced guiding mechanism in a further development according to the invention.

The surface, in which the jet outlet elements are arranged, can feature an arbitrary form. It is particularly advantageous, however, if this surface is a level surface.

To achieve that the jet outlet elements discharge the outlet jets in a defined direction, which is particularly important in an arrangement of the jet outlet elements in a surface, it can be provided in a further development of the invention that the jet outlet elements are formed as nipples that feature an outlet channel, which leads to a jet outlet opening. Careful alignment of the direction of the outlet jets takes place through the channel.

In a further development of the invention, it can be provided that the jet outlet elements, in particular the nipples, are mounted in a swiveling manner in the showerhead. By swiveling the jet outlet elements together, the direction of water jets can be changed together.

In particular, it can be provided that the jet outlet elements are made of or formed on a membrane of elastomeric material. This membrane can additionally take on sealing functions.

If the jet outlet elements involve nipples, it can be provided according to the invention that these penetrate through the openings of a disc disposed in the showerhead, which is guided in a displaceable manner relative to the rest part of the showerhead and the displacement of which determines or changes the direction of the outlet jets.

The openings in the disc must hence be slightly larger than the outer diameter of the nipple so that, change of the direction of the nipple takes place through the displacement.

In order not to let the details of the type of the change of direction be too obvious, the showerhead housing can additionally be covered by an external cover, which is designed according to aesthetic or artistic points of view.

In particular, the showerhead housing according to the invention can be designed as a flat level shower, for example with a square face surface.

The invention proposes that the adjustment of the direction be designed in a defined manner, so that a set direction can be retained.

According to the invention, a neutral or zero position can also be provided, which can be fixable by the user by a click-stop device or similar.

Further features, details and preferences of the invention result from the claims and the abstract, wherein both wordings refer to the content of the description, of the following description of preferred embodiments of the invention and of the drawing. The figures are as follows:

FIG. 1 shows a section through a showerhead according to the invention

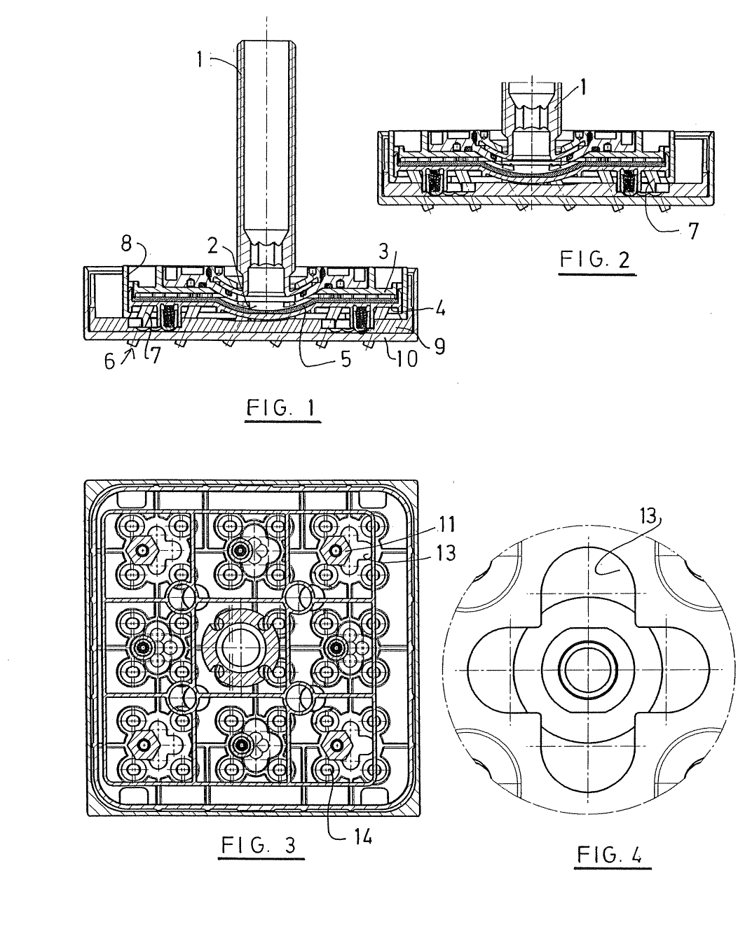

FIG. 2 shows the same section of the jet outlet elements in a second position

FIG. 3 shows a section through the showerhead housing in a transverse plane relative to the direction of FIG. 1

FIG. 4 shows the type of forced guiding mechanism for displacement, in a magnified scale

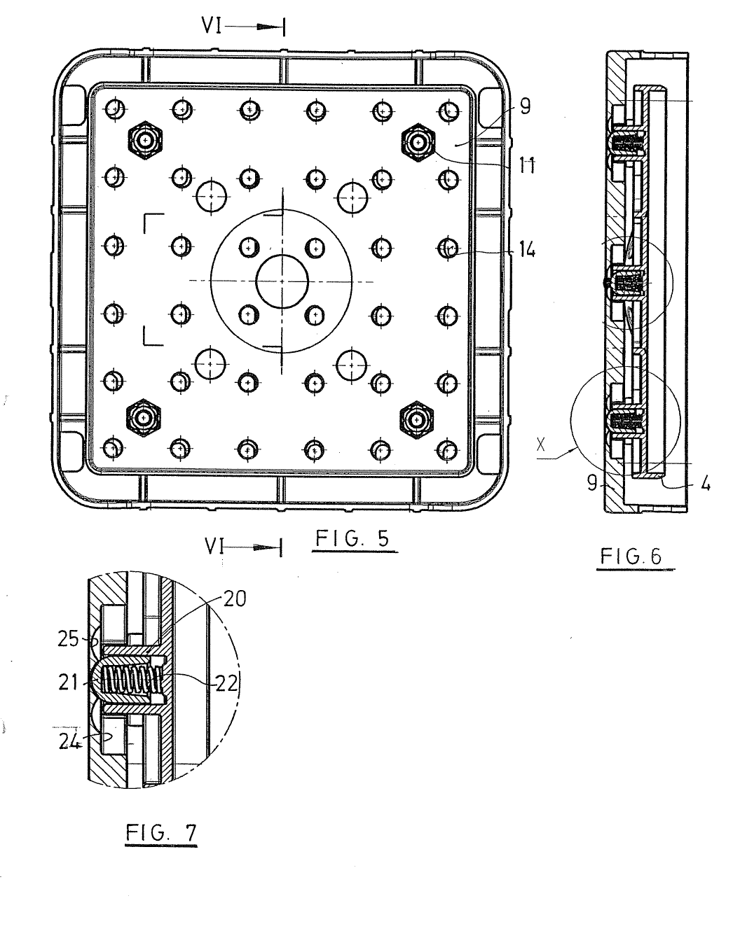

FIG. 5 shows a front view of the housing with a removed cover

FIG. 6 shows a section along the longitudinal line VI-VI in FIG. 5

FIG. 7 shows a magnified detail view

A connection nozzle 1 that serves for the connection with a water hose leads from the rear side in the showerhead housing shown in FIG. 1. The showerhead housing contains a chamber 2 that is demarcated by a rear wall 3 and a front wall 4 running approximately parallel to former.

A membrane 5 lies on the inner side of the front wall 4. On the membrane 5, jet outlet elements 6 are formed in form of elongated nipples 7. The nipples project forward through the front wall 4.

A frame 8 is formed around the chamber 2 formed between der rear wall 3 and the front wall 4.

Opposite the connection nozzle 1, in front of the front wall 4, a perforated disc 9 is disposed in a displaceable manner in the direction of its own plane in FIG. 1 towards the right and left as well as upwards and downwards. The perforated disc 9 contains an opening for each jet outlet element that is slightly larger than the outer diameter of the respective nipples 7. In the position that the perforated disc 9 takes in FIG. 1 all the nipples 7 are shifted such that its front end that forms the jet outlet opening is further left than its connection with the membrane 5. If one now shifts the perforated disc 9 from the position of FIG. 1 towards the right, then the nipple 7 reaches the position depicted in FIG. 2.

A cover 10 covering the perforated disc 9 frontally and peripherally is disposed in front of the perforated disc 9.

As can be seen in the section of FIG. 3, for the connection of the perforated disc 9 with the other showerhead housing, a row of fixing elements 11 is provided, which feature a nut-type head 12. These elements 11 penetrate from the unit formed by the rear wall 3, front wall 4 and frame 8 through the openings 13 to the front into the perforated disc 9. These openings 13 of the perforated disc 9 are depicted in FIG. 4 in a magnified scale. Each opening 13 features the form of two overlapping ovals, wherein the ovals are equipped with parallel sides. Through this, it is possible to limit the direction of the displacement of the perforated disc 9 to two directions perpendicular to one another, and hence also the extent of the displacement.

The perforated disc 9 also features openings 14 for the nipples 7 of the jet outlet elements 6 to break through, besides the openings 13 for the fixing elements 11.

FIG. 5 shows a front view of the showerhead housing with a removed cover 10. In the front view, it is visible that the perforated disc 9 is in a middle position in the position depicted here. As already mentioned, four fixing means 11 seen as hexagon heads in FIG. 5 serve for fixing purposes.

Moreover, passage openings 14 for the nipples 7 disposed in six rows are apparent. There are 36 openings for the corresponding 36 nipples 7.

FIG. 6 shows a cross-section along line VI-VI in FIG. 5. On the front side of the front wall 4, hollow nozzles 20 are formed, see also FIG. 7. In the hollow nozzles 20 pressure pieces 21 are accommodated, which are pressurized by a pressure spring 22 from the hollow nozzle 20. The pressure pieces 21 feature a rounded front side, which they are pressurized against the rear side of the perforated plate 9. In the rear side of the perforated disc 9, the recesses 23, in which the hollow nozzles 20 interlock, are formed. Centrally on the base 24 of each recess 23, there are partially spherical depressions 25, which interact with the rounded front side of the pressure pieces 21. FIG. 7 shows the interlocking of the pressure piece 21 in a middle depression 25 according to a middle or zero position of the perforated disc 9 and thus of a zero position of the direction of the water jets discharging from the nipples 7. By looking carefully, one can detect the depressions 25, which are depicted in a larger scale in FIG. 7 and also in FIGS. 1 and 2.

For the displacement of the perforated disc 9 and hence for concurrent adjustment of the direction of the water jets discharging from the jet outlet elements, a user can intervene on the external side of the cover disc 10 and displace it, wherein the direction and the extent of the displacement is determined through the form of the openings 13.

1. A showerhead for a sanitary fitting, comprising:
plurality of jet outlet elements, which jet outlet elements each discharge shower water as an outlet jet in a defined direction, the jet outlet elements being disposed over a surface in two dimensions, wherein the defined direction of the outlet jets of all said jet outlet elements is adjustable together in at least two directions, which directions are at an angle to one another.

2. The showerhead according to claim 1, further comprising a showerhead housing, and wherein the showerhead is configured such that a user can change the defined direction of the outlet jets by actuating the showerhead housing.

3. The showerhead according to claim 1, further comprising a mechanical guide arranged to determine an adjustment direction for determining the defined direction of the outlet jets of all said jet outlet elements in said at least two directions.

4. The showerhead according to claim 1, wherein the jet outlet elements are disposed in a plane surface.

5. The showerhead according to claim 1, wherein the jet outlet elements are disposed in a dome-shaped surface.

6. The showerhead according to claim 1, wherein jet outlet openings formed on the jet outlet elements are disposed in a plane surface.

7. The showerhead according to claim 1, wherein jet outlet openings formed on the jet outlet elements are disposed in a dome-shaped surface.

8. The showerhead according to claim 1, wherein the jet outlet elements comprise nipples with an outlet duct leading to a jet outlet opening.

9. The showerhead according to claim 1, wherein the jet outlet elements are mounted in the showerhead in a manner allowing swivelling.

10. The showerhead according to claim 1, wherein the jet outlet elements are formed of a membrane comprising an elastomeric material.

11. The showerhead according to claim 8, wherein the nipples penetrate through openings of a disc guided in the showerhead such that displacement of the disc changes the defined direction of the outlet jets.

12. The showerhead according to claim 1, further comprising a cover outwardly limiting the showerhead.

13. The showerhead according to claim 1, wherein the showerhead housing is substantially flat.

14. The showerhead according to claim 1, wherein adjustment of the defined direction of the outlet jets has a zero position.

15. The showerhead according to claim 1, further comprising devices associated with the jet outlet elements for fixing the defined direction of the jet outlet elements to preferred positions.

16. The showerhead according to claim 1, wherein the jet outlet elements are formed on a membrane comprising an elastomeric material.

17. The showerhead according to claim 11, wherein the jet outlet elements are mounted in the showerhead in a manner allowing swivelling.

18. The showerhead according to claim 11, wherein the jet outlet elements are mounted with a membrane comprising an elastomeric material.

19. The showerhead according to claim 15, wherein the devices associated with the jet outlet elements for fixing the defined direction of the jet outlet elements to preferred positions comprise a grid.
